(19) United States
(12) Patent Application Publication
(10) Pub. No.: US 2003/0223341 A1
(43) Pub. Date: Dec. 4, 2003

(54) Apparatus, method and recording medium for only reproducing or recording/reproducing information with approximate analyzer

(75) Inventor: Noboru Minagawa, Saitamaken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: PIONEER CORPORATION

(21) Appl. No.: 10/448,005

(22) Filed: May 30, 2003

(30) Foreign Application Priority Data
May 30, 2002 (JP) 2002-157372

(51) Int. Cl. G11B 7/005

(52) U.S. Cl. 369/59.22

(57) ABSTRACT

Recording and reproduction are performed on an information recording medium at high density. Marks having front and rear edges deviated in M levels in accordance with multilevel data are recorded at predetermined mark intervals. In information reproduction, adjoining front and rear edges are read at the same time to generate read data in succession when a spot area of a reading light beam falls on mark reference positions and space reference positions. Approximate analysis such as Viterbi decoding is performed to compare the read data with predetermined expected value data. Based on the result, the deviations of the front and rear edges of each mark are determined to decode the multilevel data. Here, a row of reference marks having front and rear edges corresponding to combinations of M levels of deviation is recorded as if the foregoing marks are. The row of reference marks is read as if the foregoing marks are, so that the expected value data for the approximate analysis is obtained. Since adjoining front and rear edges of the marks are read at the same time, the mark intervals can be reduced to achieve high density recording and reproduction. It is also possible to achieve information reproduction of high quality even if the read data is effected by nonlinear characteristics of the reproduction optical system.

### BACKGROUND OF THE INVENTION

The present invention relates to: an information reproducing apparatus and information-reproducing method for reproducing information from an information recording medium such as are writable optical disc, a write once optical disc, and a read only optical disc; an information recording/reproducing apparatus and information recording/reproducing method for recording/reproducing information on/from an information recording medium; and an information recording medium to be subjected to these apparatuses and methods.

Recent years have seen advances in audio video technology, communications technology, computer technology and such, with the progression of multimedia, a fusion of these technologies. Development has been desired, accordingly, of information processing technology which allows large volumes of information to be handled more effectively.

Under the circumstances, research and development aimed at information recording media of higher densities and larger capacities necessary for information processing is under way. For instance, a so-called multilevel recording/reproducing method has been attempted to achieve multilevel information recording/reproduction with a single mark.

Here, the mark corresponds to a pit which is conventional known recorded in a read only compact disc (CD-ROM). For example, in information recording media capable of recording and reproduction, such as a phase change type information recording medium, the mode of information recorded is typically called a mark, not a pit.

In this conventional multilevel recording/reproducing method, as shown in FIG. 14A, marks are formed (recorded) on a recording surface of an information recording medium (hereinafter, referred to as “optical disc”) with their front and rear edges deviated in position. The difference in deviation makes it possible to record multilevel information even with a single mark and achieve improved recording capacity, i.e., larger capacity.

Now, to read multilevel-recorded marks and reproduce information by the conventional multilevel recording/reproducing method, a row of marks PT1, PT2, PT3 . . . recorded in the track direction is irradiated with a light beam for reading (hereinafter, referred to as “reading light beam”) for successive scan.

When the circular range of irradiation (hereinafter, referred to as “spot area”) SA1, SA2, SA3 . . . of the reading light beam on the recording surface falls on a position to cover one of the front and rear edges of the marks, a light receiving device receives the reflected light, or the irradiation of the reading light beam reflected from the recording surface. Based on a change in a photoelectric conversion signal output from the light receiving device, the foregoing deviation is detected and the information recorded as a mark is reproduced from the deviation detected.

That is, when the spot area covers a front edge or a rear edge of each mark as shown in FIG. 14A and the reflected light occurring at that time is received, the photoelectric conversion signal Sdet shows any of a plurality of levels depending on the magnitude of the deviation of the front edge or rear edge as shown in FIG. 14B. Then, as shown in FIG. 14B, the level of the foregoing photoelectric conversion signal Sdet is sampled in synchronization with a sample clock CLK which is synchronous with the cycle of predetermined constant mark intervals T (see times t1, t2, t3 . . . in the diagram). Based on the level obtained by the sampling, the deviation of the front edge or rear edge is detected and the recorded information is reproduced.

Suppose that in the conventional multilevel recording/reproducing method, so-called information read is performed by using the foregoing reading light beam and the spot area covers a front edge and a rear edge simultaneously. Then, information on both edges, characterized by the deviations of the front edge and the rear edge, is read at the same time. It is therefore impossible to separate the photoelectric conversion signal Sdet to reproduce the information on each. Thus, in order to ensure that the spot area covers only one of the front and rear edges, the recording and reproduction are performed such that the radius r of the spot area and the mark interval T satisfy the condition of 2r<T.

That is, a front edge and a rear edge can be simultaneously covered with the spot area in either of the following two cases: where a single mark is all covered with the spot area, so that the rear edge and the front edge of the single mark are covered at the same time; and where the front edge of either one of adjoining marks and the rear edge of the other mark are covered with the spot area at the same time.

In these two cases, though information reading can be performed, it is impossible to separate the information on both edges, recorded in the form of deviations of the front and rear edges, for reproduction. The foregoing relationship between the radius r of the spot area and the mark interval T is thus determined in advance so that no other front edge or rear edge is covered with the spot area when the center position of the spot area generally coincides with the position of either one of the front and rear edges (i.e., at an instance when the foregoing sampling is performed).

Moreover, even if the front edge and the rear edge alone are irradiated with reading light beams of narrowed beam diameters pinpointedly, it is impossible to detect the deviations of the front edge and the rear edge. That is, the deviations of the front edge and the rear edge are the distances from a reference position Q to the front edge and the rear edge, respectively, with the position of every predetermined mark interval T as the reference position Q.

As above, in the conventional multilevel recording/reproducing method, individual marks are recorded with their front and rear edges deviated in a plurality of levels in the track direction. This makes it possible to record/reproduce large volumes of information.

By the way, the conventional multilevel recording/reproducing method described above increases the recording capacity of the optical disc and thereby improves the recording density relatively by changing the deviations of the front and rear edges of individual marks during recording.

As stated previously, however, the mark interval T must be wider than twice the radius r of the spot area since the front and rear edges of the marks need to be read separately. This has caused a problem that the recording density of the marks is difficult to be improved physically.

### SUMMARY OF THE INVENTION

The present invention has been achieved to overcome these basic problems of the conventional art. It is thus an object of the present invention to provide an information reproducing apparatus, an information recording/reproducing apparatus, an information reproducing method, and an information recording/reproducing method capable of improving the recording density of an information recording medium and increasing the recording capacity of the same, and an information recording medium suited to achieving high density recording and the like.

The information reproducing apparatus according to a first aspect of the present invention is an information reproducing apparatus for reproducing an information recording medium, a row of marks being recorded on a track on the information recording medium with individual mark ends deviated in M levels (M is a positive integer) so that the mark ends record M-valued multilevel data. The apparatus comprises: a reader for optically reading two mark ends adjoining in front and behind on said track at the same time, and outputting read data; and a decoder for reproducing the multilevel data based on a result of comparison between a level of the read data and a plurality of expected values. The expected values have respective different levels each of which corresponds to a combination of two pieces of multilevel data recorded on a mark end, respectively.

This information reproducing apparatus reproduces information from an information recording medium on which so-called multilevel recording has been performed. At the time of the information reproduction, two mark ends adjoining in front and behind out of the row of marks recorded are optically read at the same time. Read data containing the information on the two mark ends is obtained thereby. Besides, the expected values and the read data are compared to decode the information on each mark end, i.e., multilevel data.

The information reproducing apparatus according to a second aspect of the present invention is an information reproducing apparatus for reproducing an information recording medium, a row of marks being recorded on a track on the information recording medium with respective mark sizes deviated in M levels (M is a positive integer) so that the marks record M-valued multilevel data. The apparatus comprises: a reader for optically reading two marks adjoining in front and behind on the track at the same time, and outputting read data; and a decoder for reproducing the multilevel data based on a result of comparison between a level of the read data and a plurality of expected values. The expected values have respective different levels each of which corresponds to a combination of two pieces of multilevel data recorded on the two marks, respectively.

This information reproducing apparatus reproduces information from an information recording medium on which so-called multilevel recording has been performed. At the time of the information reproduction, two marks adjoining in front and behind out of the row of marks recorded are optically read at the same time. Read data containing the information on the two mark ends is obtained thereby. Besides, the expected values and the read data are compared to decode the information on each mark, i.e., multilevel data.

In short, the information reproducing apparatus according to the first aspect reads two adjoining “mark ends” simultaneously, while the information reproducing apparatus according to the second aspect reads two adjoining “marks” simultaneously.

The information recording/reproducing apparatus according to a third aspect of the present invention is an information recording/reproducing apparatus for recording and reproducing recording data on/from an information recording medium. The apparatus comprises: a mark end deviating device for recording a row of marks on a track on the information recording medium so that individual mark ends are deviated in M levels in accordance with M-valued multilevel data (M is a positive integer); a reader for optically reading two mark ends adjoining in front and behind on said track at the same time, and outputting read data; and a decoder for reproducing the multilevel data based on a result of comparison between a level of the read data and a plurality of expected values. The expected values have respective different levels each of which corresponds to a combination of two pieces of multilevel data recorded on a mark end, respectively.

This information recording/reproducing apparatus performs so-called multilevel recording on an information recording medium. At the time of information reproduction, two mark ends adjoining in front and behind out of the row of marks recorded on the information recording medium are optically read at the same time. Read data containing the information on the two mark ends is obtained thereby. Besides, the expected values and the read data are compared to decode the information on each mark end, i.e., multilevel data.

The information recording/reproducing apparatus according to a fourth aspect of the present invention is an information recording/reproducing apparatus for recording and reproducing recording data on/from an information recording medium. The apparatus comprises: a mark size deviating device for recording a row of marks on a track on said information recording medium so that respective mark sizes are deviated in M levels in accordance with M-valued multilevel data (M is a positive integer); a reader for optically reading two marks adjoining in front and behind on said track at the same time, and outputting read data; and a decoder for reproducing the multilevel data based on a result of comparison between a level of the read data and a plurality of expected values. The expected values have respective different levels each of which corresponds to a combination of two pieces of multilevel data recorded on the two marks, respectively.

This information recording/reproducing apparatus performs so-called multilevel recording on an information recording medium so that mark sizes are deviated in M levels (mark sizes vary in M levels). At the time of information reproduction, two marks adjoining in front and behind out of the row of marks recorded on the information recording medium are optically read at the same time. Read data containing the information on the two marks is obtained thereby. Besides, the expected values and the read data are compared to decode the information on each mark, i.e., multilevel data.

The information reproducing method according to a fifth aspect of the present invention is an information reproducing method for reproducing information from an information recording medium, a row of marks being recorded on a track on the information recording medium with respective mark ends deviated in M levels (M is a positive integer) so that the mark ends record M-valued multilevel data. The method comprises: a reading step of optically reading two mark ends adjoining in front and behind on said track at the same time, and outputting read data; and a decoding step of reproducing the multilevel data based on a result of comparison between a level of the read data and a plurality of expected values. The expected values have respective different levels each of which corresponds to a combination of two pieces of multilevel data recorded on a mark end, respectively.

In this information reproducing method, information is reproduced from an information recording medium on which so-called multilevel recording has been performed. At the time of the information reproduction, two mark ends adjoining in front and behind out of the row of marks recorded are optically read at the same time. Read data containing the information on the two mark ends is obtained thereby. Besides, the expected values and the read data are compared to decode the information on each mark end, i.e., multilevel data.

The information recording/reproducing method according to a sixth aspect of the present invention is an information recording/reproducing method for recording and reproducing recording data on/from an information recording medium. The method comprises: a mark end deviating step of recording a row of marks on a track of said information recording medium so that individual mark ends are deviated in M levels in accordance with M-valued multilevel data (M is a positive integer); a reading step of optically reading two mark ends adjoining in front and behind on said track at the same time, and outputting read data; and a decoding step of reproducing the multilevel data based on a result of comparison between a level of the read data and a plurality of expected values. The expected values have respective different levels each of which corresponds to a combination of two pieces of multilevel data recorded on a mark end, respectively.

In this information recording/reproducing method, so-called multilevel recording is performed on an information recording medium. At the time of information reproduction, two mark ends adjoining in front and behind out of the row of marks recorded on the information recording medium are optically read at the same time. Read data containing the information on the two marks is obtained thereby. Besides, the expected values and the read data are compared to decode the information on each mark, i.e., multilevel data.

The information recording medium according to a seventh aspect of the present invention is an information recording medium for an information reproducing apparatus to reproduce information from or an information recording medium for an information recording/reproducing apparatus to record/reproduce information on/from. A row of M or more predetermined reference marks out of M×M marks having their front and rear edges deviated in position in M levels (M is a positive integer) independently is recorded on the information recording medium.

This information recording medium contains a row of M or more predetermined reference marks out of M×M marks having front and rear edges, or so-called mark ends, deviated in position in M levels independently. When the information reproducing apparatus or the information recording/reproducing apparatus performs information reproduction, the row of reference marks is read and the resulting information on the reference marks, necessary for decoding, is provided as teaching data.

### BRIEF DESCRIPTION OF THE DRAWINGS

These and other objects and advantages of the present invention will become clear from the following description with reference to the accompanying drawings, wherein:

FIG. 1 is a block diagram showing the configuration of an information recording/reproducing apparatus according to an embodiment;

FIG. 2 is a diagram showing the details of a write signal generating unit and a decoding unit;

FIG. 3 is a diagram showing the principle of generation of a write signal;

FIG. 4 is a diagram showing the configurations of marks for multilevel recording;

FIG. 5 is a diagram showing the location for recording reference marks and such;

FIGS. 6A to 6B are diagrams showing the physical relationship between a row of marks recorded on an optical disc and a reading light beam, the method of reading and reproducing the row of marks, and so on;

FIGS. 7A to 7B are diagrams showing the principle of generation of expected value data;

FIGS. 8A to 8B are diagrams also showing the principle of generation of expected value data;

FIGS. 9A and 9B are diagrams for explaining a concrete example where information reproduction is performed through the application of the Viterbi decoding;

FIG. 10 is a trellis diagram;

FIG. 11 is a chart for explaining the process of creating the trellis diagram;

FIG. 12 is a chart summarizing the processing for the case where information reproduction is performed through the application of the Viterbi decoding;

FIG. 13 is a diagram showing other configurations of the marks for multilevel recording; and

FIGS. 14A to 14B are diagrams for explaining a conventional information recording/reproducing method.

### DETAILED DESCRIPTION OF THE PREFERRED EMBODIMENTS

A preferred embodiment of the present invention will be described with reference to the drawings.

For the preferred embodiment, description will be given of an information recording/reproducing apparatus which can reproduce information from a read only information recording medium, and can record/reproduce information on/from write once and rewritable information recording media.

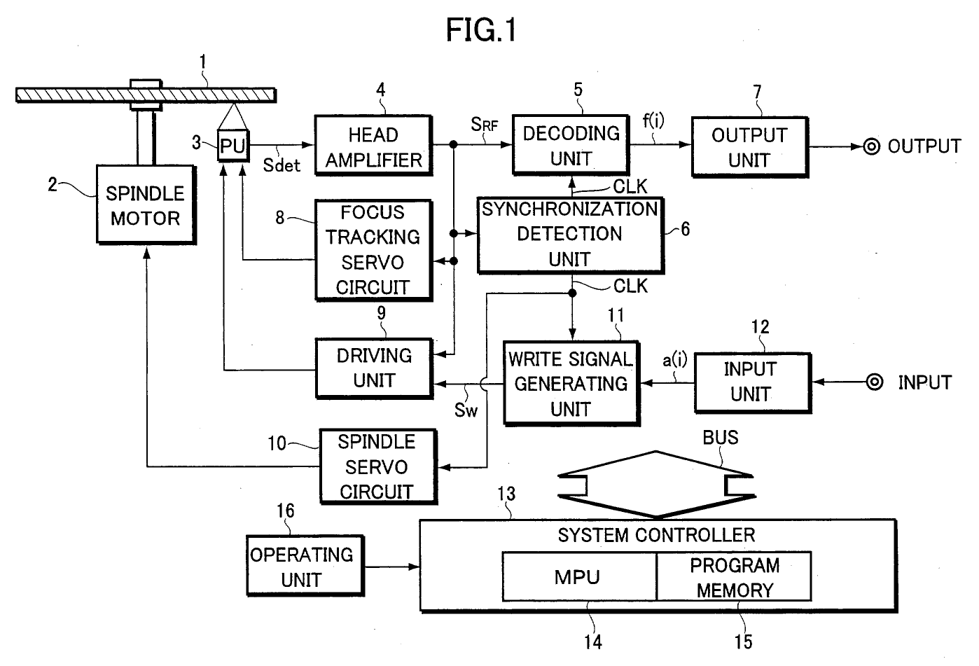

FIG. 1 is a block diagram showing the configuration of the information recording/reproducing apparatus. The information recording/reproducing apparatus includes a system controller 13 for exercising centralized control on the information recording/reproducing apparatus, and an operating unit 16 from which users enter desired instructions.

The system controller 13 has a microprocessor (MPU) 14 for executing a predetermined system program and a read only memory (ROM) 15 for storing the system program in advance. In accordance with user instructions from the operating unit 16, the system controller 13 performs the foregoing system program to exercise centralized control on the operations of information recording and information reproduction.

The microprocessor 14 in the system controller 13 is connected to components 4-12, or a head amplifier 4 through an input unit 12 to be described later, through a control bus and a data bus BUS. This allows the centralized control of the system controller 13.

The information recording/reproducing apparatus also includes a spindle motor 2, a pickup 3, a head amplifier (also referred to as RF amplifier) 4, a decoding unit 5, a synchronization detection unit 6, an output unit 7, a focus tracking servo circuit 8, a driving unit 9, a spindle servo circuit 10, a write signal generating unit 11, and an input unit 12. The spindle motor 2 clamps and rotates an information recording medium (hereinafter, referred to as “optical disc”) 1 mentioned above. The pickup 3 performs information write and information read on the disc 1. The decoding unit 5 and the output unit 7 constitute an information reproduction system. The write signal generating unit 11 and the input unit 12 constitute an information recording system. The decoding unit 5, the output unit 7, the write signal generating unit 11, and the input unit 12 are made of such components as a digital signal processor (DSP) for operating in accordance with the instructions of the system controller 13, a programmable logic array (PLA), and a semiconductor memory for storing various kinds of data during data processing.

The pickup 3 has an optical system which includes such components as a semiconductor laser for irradiating a recording surface of the disc 1 with a writing light beam at the time of information recording and irradiating the same with a reading light beam BM at the time of information reproduction.

The optical system of the pickup 3 also includes a light receiving device for receiving both reflected light which is the irradiation of the writing light beam reflected from the optical disc 1 and reflected light which is the irradiation of the reading light beam BM reflected from the optical disc 1, and outputting a photoelectric conversion signal Sdet corresponding to the intensities of these refection lights.

The head amplifier 4 amplifies or otherwise processes the photoelectric conversion signal Sdet from the pickup 3 and outputs a so-called RF signal S_{RF}.

The focus tracking servo circuit 8 detects fluctuation errors of the RF signal S_{RF} and fine-adjusts the position of the pickup 3 so that the pickup 3 is prevented from causing a focus error and a tracking error with respect to the optical disc 1 during information recording and information reproduction.

The driving unit 9 supplies the above-mentioned semiconductor laser with electric power so as to emit the writing light beam and the reading light beam BM. The driving unit 9 also exercises feedback control on the emission power of the semiconductor layer by using an automatic power control circuit (APC) built therein.

More specifically, in information recording, the driving unit 9 supplies power in accordance with a write signal Sw supplied from the write signal generating unit 11, and exercises feedback control on the emission power of the semiconductor laser so as to suppress level fluctuations of the RF signal S_{RF}, thereby setting the writing light beam to appropriate power. In information reproduction, the driving unit 9 exercises feedback control on the emission power of the semiconductor laser so as to suppress level fluctuations of the RF signal S_{RF}, thereby adjusting the reading light beam BM to constant power.

In information recording and information reproduction, the synchronization detection unit 6 detects synchronization information recorded on the optical disc 1 out of the RF signal S_{RF}, and generates and outputs a synchronization signal CLK corresponding to the rotational angular speed of the optical disc 1.

The spindle servo circuit 10 exercises feedback control on the rotational angular speed of the spindle motor 2 such that a difference between the synchronization signal CLK output from the synchronization detection unit 6 and a predetermined target value becomes zero. The spindle servo circuit 10 thereby fine-adjusts the rotational angular speed of the optical disc 1 and the frequency (in other words, cycle) of the synchronization signal CLK to constant values.

In information recording, the input unit 12 subjects external input data input from external equipment etc., such as voice data and image data, to predetermined data compression as well as modulation and the like compliant with a given modulation system determined by the optical disc 1. The input unit 12 outputs recording data a (i) which is given the data compression, modulation, and the like.

The write signal generating unit 11 converts the recording data a(i) into the write signal Sw, and supplies it to the driving unit 9. Here, predetermined coding is applied to a row of recording data a(i) to generate a row of coded data b(i). The individual pieces of data b(i) in the row of coded data b(i) are then converted into a write signal Sw for multilevel recording, which is supplied to the driving unit 9. The details will be given later. Consequently, the driving unit 9 makes the semiconductor laser emit a writing light beam corresponding to the write signal Sw for multilevel recording. Recording marks PT corresponding to the recording data a(i) are thus formed (recorded) on the recording surface of the write once or rewritable optical disc 1 by the writing light beam.

In information reproduction, the decoding unit 5 inputs the RF signal S_{RF} with A/D conversion. Then, a row of read data c(i) resulting from the A/D conversion is subjected to predetermined decoding, so that the information on the marks PT recorded on the write once, rewritable, or read only optical disc 1 is decoded to output decoded data f(i). Here, in generating the decoded data f(i) from the row of read data c(i), Viterbi decoding or other processing is performed for improved decoding accuracy. The details will be given later.

The output unit 7 applies demodulation processing such as data decompression to the decoded data f(i) from the decoding unit 5. Moreover, from the demodulated data, the output unit 5 reproduces the information recorded on the optical disc 1, such as music and images, and outputs it in the form of voice data and picture data reproducible by speakers and a display.

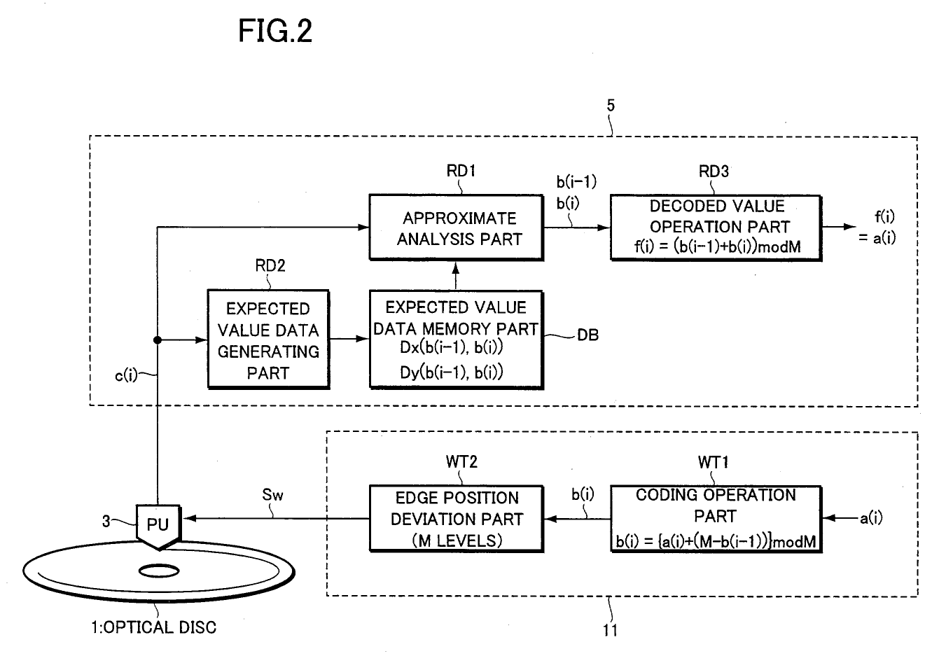

Now, the functions of the write signal generating unit 11 and the decoding unit 5 described above will be discussed in further details with reference to FIGS. 2 through 8B.

FIG. 2 is a diagram schematically showing the functions of the write signal generating unit 11 and the decoding unit 5.

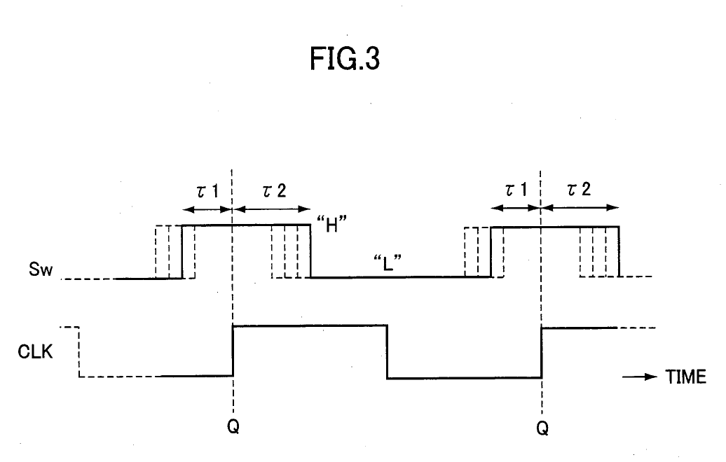

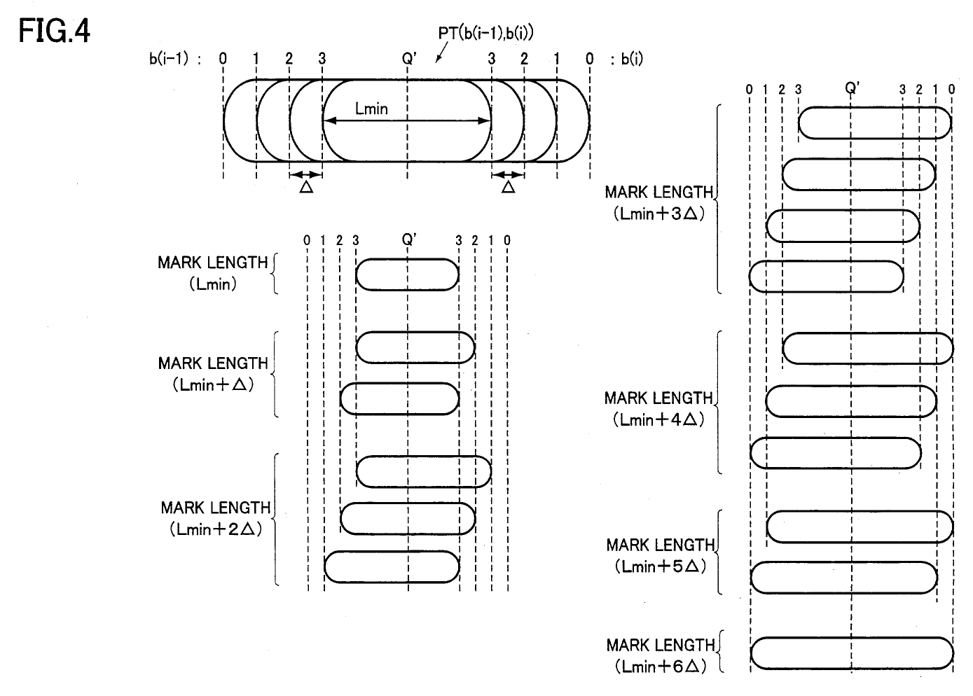

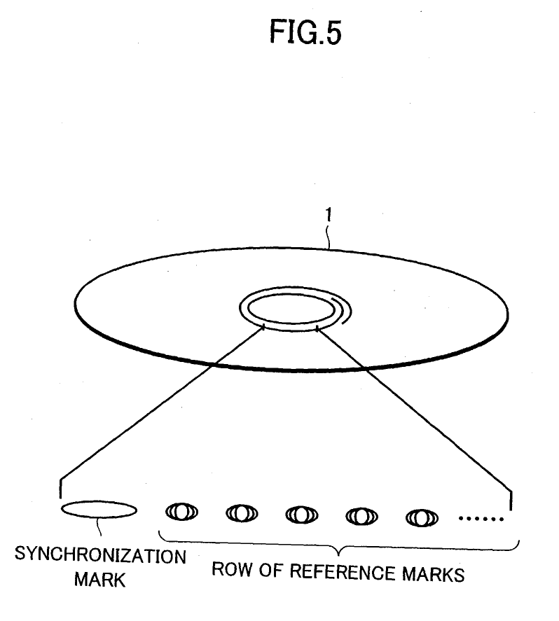

FIG. 3 is a diagram showing the principle of generation of the write signal Sw to be generated by the write signal generating unit 11. FIGS. 4 and 5 are diagrams showing the configurations of marks PT to be recorded on a write once or rewritable optical disc 1 in accordance with the write signal Sw.

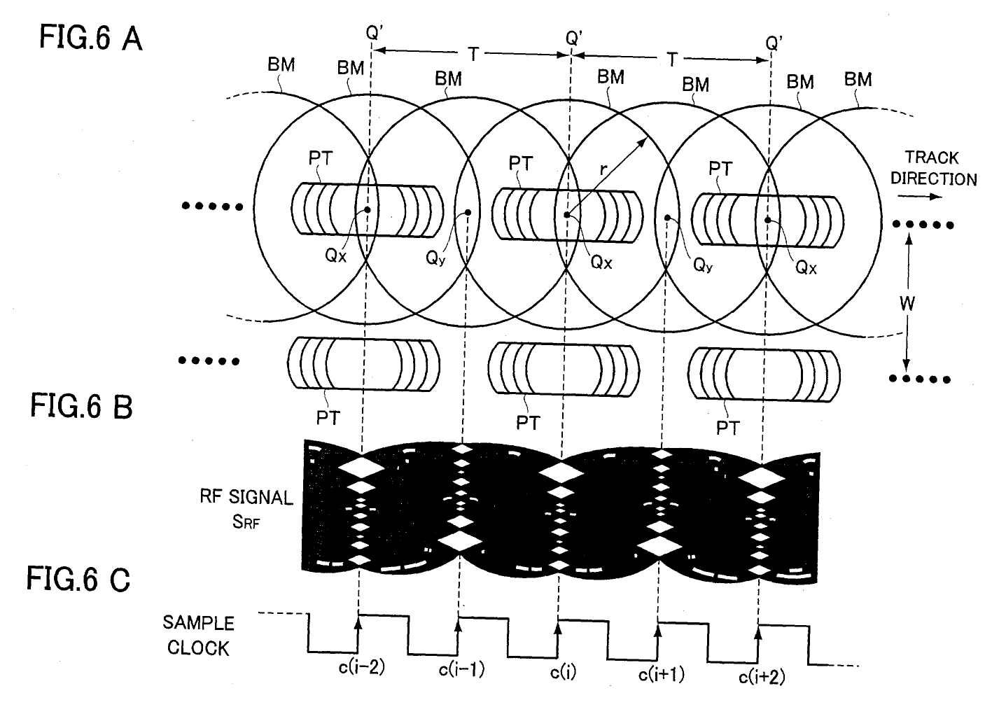

FIGS. 6A-6B are diagrams showing the physical relationship and the like between a row of marks PT information-recorded on the optical disc 1 and the reading light beam BM for irradiation during information reproduction.

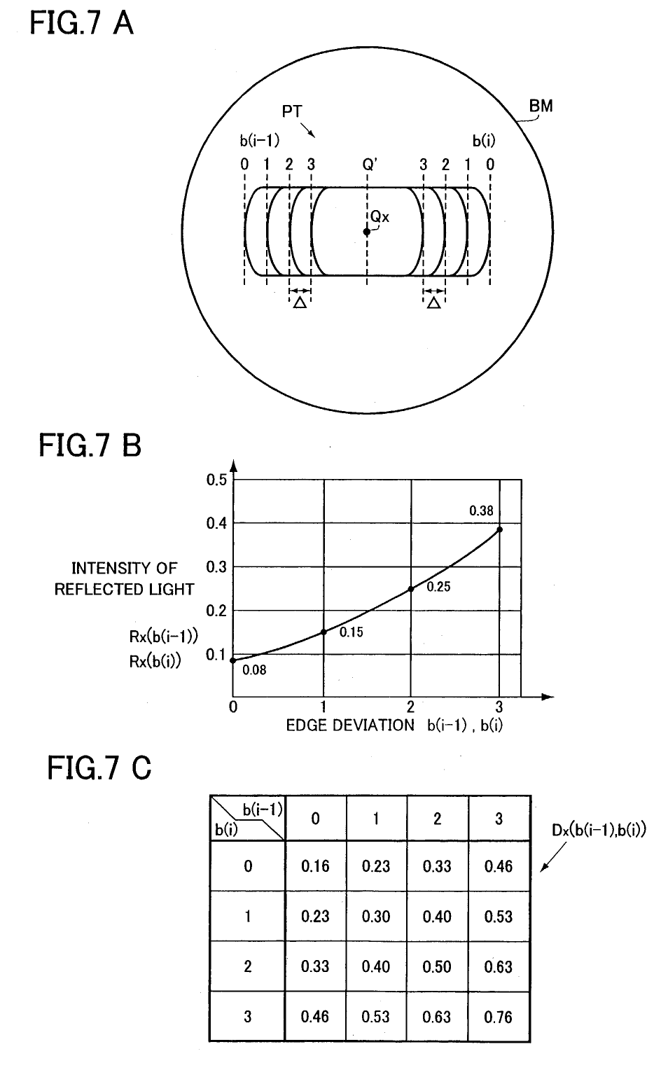

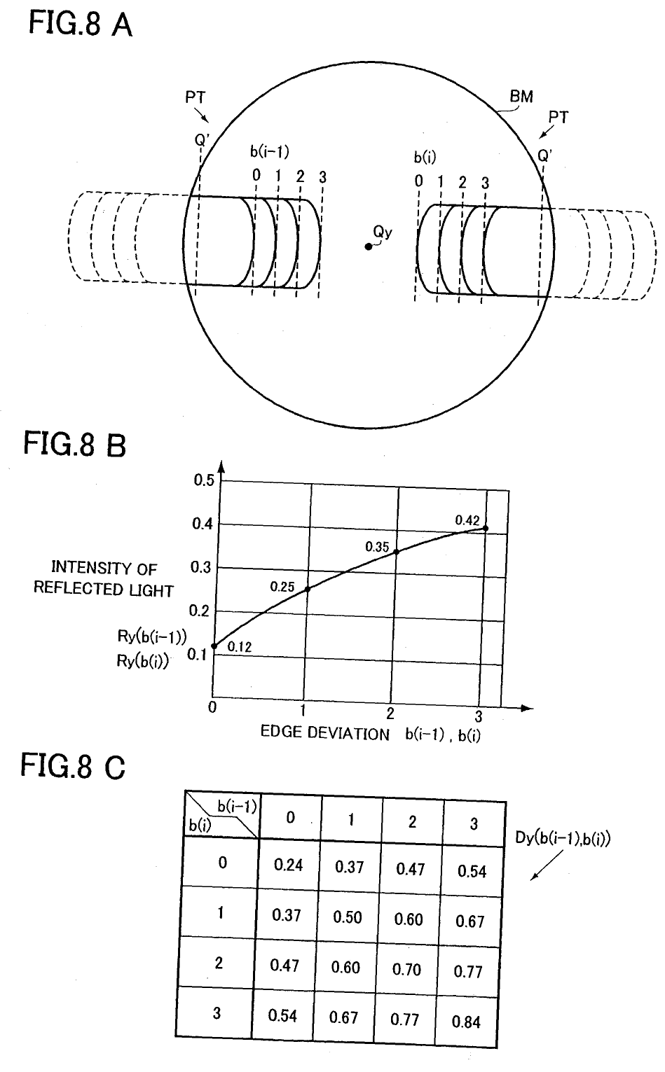

FIGS. 7A through 8B are diagrams for explaining the principle of decoding in the decoding unit 5.

Initially, description will be given of the function of the write signal generating unit 11 in information recording.

In FIG. 2, the write signal generating unit 11 has a coding operation part WT1 and an edge position deviation part WT2, which are made of DSPs and/or PLAs.

When a row of recording data a(i) is supplied in succession from the input unit 12, the coding operation part WT1 generates and outputs a row of coded data b(i) by performing a coding operation given by the following equation (1) in synchronization with the synchronization signal CLK described previously.

b(i)={a(i)+(M−b(I−1))}modM (1)

Here, the variable i indicates the sequences of the recording data a(i) and the coded data b(i). The variable M is a positive integer for indicating the number of levels of deviation between mark ends of a mark PT to be formed (recorded) on the optical disc 1, i.e., the front mark end (hereinafter, referred to as “front edge”) and the rear mark end (hereinafter, referred to as “rear edge”) of a mark PT mod M represents that a remainder operation is performed on the right-side calculation {a(i)+(M−b(i−1))} with M as the modulus. The variable M shall be set at a predetermined fixed value in advance in accordance with the instruction from the system controller 13.

The effect of the coding operation given by the foregoing equation (1) will be explained later. The foregoing equation (1) satisfies the relationship that the sum of generated coded data b(i−1) and b(i), or b(i−1)+b(i), makes the value of the original recording data a(i). In other words, the equation is a coding formula for generating the coded data b(i−1) and b(i) so as to satisfy the relationship that the original recording data a(i) minus the coded data b(i−1) makes the coded data b(i).

Note that the remainder operation using the variable M as the modulus shall be performed on the right-side calculation {a(i)+(M−b(i−1))} of the foregoing equation (1) so that the coded data b(i) is prevented from becoming negative or exceeding M in value.

The edge position deviation part WT2 generates the write signal Sw which is given PWM modulation in accordance with the values of the coded data b(i−1) and b(i) generated on the basis of the foregoing equation (1).

More specifically, as shown in FIG. 3, in synchronization with a reference position Q of the synchronization signal CLK generated by the synchronization detection unit 6, the period τ1 from the front end of a period of logic “H” to the position Q and the period τ2 from the position Q to the rear end of the same are separately changed in M levels in accordance with the values of the coded data b(i−1) and b(i). As a result, the write signal Sw is generated as a PWM wave having a deviation set by the periods τ1 and τ2.

Then, the write signal Sw is supplied to the driving unit 9. A mark PT is formed on the recording surface of the optical disc 1 by a writing light beam corresponding to the write signal Sw.

When marks PT are thus formed (recorded) on the recording surface of the optical disc 1 by means of the PWM-modulated write signal Sw, the forming positions Q′ of the individual marks PT are determined with reference to the reference positions Q of the synchronization signal CLK as shown in FIG. 6A. The marks PT are formed in the track direction of the optical disc 1 with the intervals of the forming positions Q′ as mark intervals T.

Moreover, in accordance with the deviations of the periods τ1 and τ2 of the write signal Sw, the forming positions of the front and rear edges are determined from the forming positions Q′ of the respective marks PT. Consequently, the front edges are formed with deviations or information showing the values of the coded data b(i−1) The rear edges are formed with deviations or information showing the values of the coded data b(i).

For example, when information recording is performed with the number of levels M of deviations set at “4,” the deviation of the front edge of each mark PT(b(i−1),b(i)) varies in integer multiples of a unit deviation Δ in accordance with the value of the coded data b(i−1) as schematically shown in FIG. 4. Similarly, the deviation of the rear edge varies in integer multiples of the unit deviation Δ in accordance with the value of the coded data b(i).

In the diagram, the part shown by the length Lmin makes the base of each mark PT(b(i−1),b(i)). With this part of smallest mark length as the base, the deviations of the front edge and rear edge vary in integer multiples of the unit deviation Δ in accordance with the values of the coded data b(i−1) and b(i). For easy understanding of the principle of multilevel recording, description here is given on the assumption that the deviations of the front and rear edges vary in integer multiples of the unit deviation Δ as the coded data b(i−1) and b(i) vary within the range of “0” and “3.”

As a result, when the number of levels M of deviation is set at “4,” each single mark PT(b(i−1),b(i)) can record 16 different levels of information.

To give a breakdown of the marks: PT(3,3) or a total of one mark having a minimum mark length of (Lmin); PT(3,2) and PT(2,3) or a total of two marks having a mark length of (Lmin+Δ); PT(3,1), PT(2,2), and PT(1,3), or a total of three marks having a mark length of (Lmin+2Δ); PT(3,0), PT(2,1), PT(1,2), and PT(0,3), or a total of four marks having a mark length of (Lmin+3Δ); PT(2,0), PT(1,1), and PT(0,2), or a total of three marks having a mark length of (Lmin+4Δ); PT(1,0) and PT(0,1), or a total of two marks having a mark length of (Lmin+5Δ); and PT(0,0) or a total of one mark having a maximum mark length of (Lmin+6Δ). These 16 types of information can be recorded by a single mark PT(b(i−1),b(i)).

In information reproduction, the recording surface of the optical disc 1 is irradiated with the reading light beam BM. Here, the relationship between the radius r of the circular spot area occurring on the recording surface and the mark interval T is determined according to the condition given by the following expression (2).

(M−1)Δ+Lmin/2<r

and

(T−Lmin)<2r (2)

More specifically, as shown in FIG. 6A, each single mark PT is recorded at the time of information recording so that the single mark PT is entirely covered with a spot area resulting from the reading light beam BM when the center of the spot area of the reading light beam BM falls on the intersecting position (hereinafter, referred to as “mark reference position”) Qx of the forming position Q′ and the track during information reproduction. In addition, the individual marks PT are recorded at mark intervals T which are determined at the time of information recording so that a single rear edge and a single front edge of two adjoining marks PT always fall within the spot area of the reading light beam BM when the spot area comes to a position Qy at a half the mark interval T, i.e., a middle position (hereinafter, referred to as “space reference position”) Qy between two mark reference positions Qx.

For example, the cycle of the synchronization signal CLK mentioned above and the cycle of the write signal Sw to be generated by the write signal generating unit 11 are set at predetermined cycles at the time of information recording, whereby the mark intervals T and the maximum mark length of the marks PT are determined to satisfy the condition of the foregoing expression (2). The marks PT are recorded accordingly.

Consequently, at the time of information reproduction to be described later, adjoining front and rear edges are irradiated with the reading light beam BM simultaneously. Then, the resulting reflected light is received to read the information on both the front edge and the rear edge.

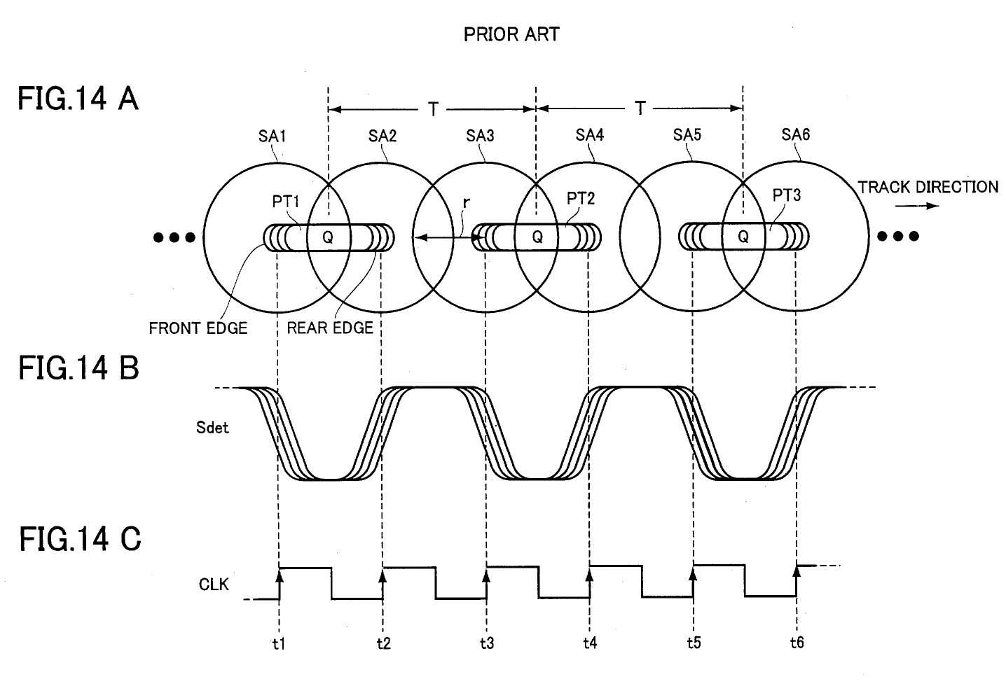

The mark intervals T can thus be made narrower than in the conventional art which has been described with reference to FIGS. 14A-14B. This allows a significant improvement in the recording density of the marks PT in the track direction.

That is, in the conventional art shown in FIGS. 14A-14B, the front and rear edges of each mark have been read and reproduced by the center of the light beam one at a time. This has required that the front edge and the rear edge of each mark not be covered by the spot area of the light beam simultaneously, precluding a reduction of the interval between the front edge and the rear edge. Thus, it has been difficult to enhance the recording density in the track direction.

In contrast, in the present invention, the front edge and the rear edge of each mark PT or the front edge and the rear edge of a pair of marks PT lying in front and behind are intentionally covered by the spot area of the light beam BM at the same time for read and reproduction. This facilitates reducing the interval between the front edge and the rear edge, allowing enhanced recording density in the track direction.

Incidentally, the information on the front edge and the rear edge cannot be reproduced separately as long as the front edge and the rear edge are simply read at the same time during information reproduction. In the present invention, the coding based on the foregoing equation (1) and the decoding performed in information reproduction to be described later make it possible to reproduce the information on the front edge and the rear edge separately. The principle thereof will be detailed in the description of the information reproduction to be given later.

Moreover, information recording is performed with fine adjustments to the position of the pickup 3 such that the interval between marks PT adjoining in the radial direction of the optical disc 1, or the track interval W, becomes greater than the radius r of the spot area of the reading light beam BM(r<W). This precludes the information on marks PT lying in the radial direction of the optical disc 1 from being read simultaneously by the reading light beam BM in information reproduction, thereby avoiding so-called cross talk and the like between tracks.

When the write signal generating unit 11 finishes recording the marks PT in a so-called program area (also referred to as data recording area) of the optical disc 1 based on the coded data b(i) which is generated from the foregoing recording data a (i), it records a total of M×M marks PT, having their front and rear edges deviated in M levels separately, in a predetermined area of the optical disc 1 as a row of reference marks. In information reproduction to be described later, the row of reference marks is used to achieve appropriate information reproduction.

That is, unlike so-called recording marks which are recorded in the program area and the like in accordance with the recording data to be recorded, the reference marks are recorded as so-called teaching data, having their front and rear edges deviated separately in accordance with multilevel recording conditions or a predetermined number of levels of deviation.

For example, as shown in FIG. 5, M×M marks PT led by a synchronization mark are recorded as a row of reference marks in a calibration area or the like arranged on a predetermined part of the optical disc 1 for the sake of initial adjustment to the emission power of the semiconductor laser in the pickup 3.

Now, description will be given of the function of the decoding unit 5 in information reproduction.

In FIG. 2, the decoding unit 5 includes an approximate analysis part RD1, an expected value data generating part RD2, an expected value data memory part DB, and a decoded value operation part RD3. The expected value data generating part RD2 generates expected value data from a row of read data c(i) which is obtained by reading the row of reference marks described above. The expected value data memory part DB stores the expected value data. The approximate analysis part RD1, the expected value data generating part RD2, and the decoded value operation part RD3 are composed of DSPs and/or PLAs. The expected value data memory part DB is made of a semiconductor memory (RAM).

When information reproduction is started, the pickup 3 initially reads the row of M×M reference marks recorded in the calibration area or the like shown in FIG. 5, under the instruction from the system controller 13. When it finishes reading the row of reference marks, the pickup 3 starts to read a row of marks recorded in the program area of the optical disc 1 under the instruction from the system controller 13.

Here, as shown in FIG. 6A, the optical disc 1 is irradiated with the reading light beam BM from the pickup 3. The reflected light reflected from the optical disc 1 is received to obtain the RF signal S_{RF} which has such an eye pattern as shown in FIG. 6B. The decoding unit 5, as shown in FIG. 6B, generates a sample clock corresponding to a half the mark interval T, or cycle T/2, from the foregoing synchronous signal CLK. The RF signal S_{RF} is sampled in synchronization with the sample clock, and is subjected to A/D conversion to generate a row of read data c(i).

Then, the row of read data c(i) obtained from the row of M×M reference marks described above is supplied to the expected value data generating part RD2. Meanwhile, the row of read data c(i) obtained from the row of marks recorded in the program area is supplied to the approximate analysis part RD1.

The expected value data generating part RD2 generates expected value data in the following way.

As described previously, while the pickup 3 is reading the row of M×M reference marks, the expected value data generating part RD2 is supplied with the following two types of rows of read data c(i): a row of read data c(i) which is obtained from the reflected light occurring when the center of the spot area of the reading light beam BM falls on the mark reference positions Qx so that the reference marks PT are each covered with the spot area; and a row of read data c(i) which is obtained from the reflected light occurring when the center of the spot area of the reading light beam BM falls on the space reference positions Qy so that the rear edge and the front edge of adjoining reference marks PT are covered with the spot area.

The expected value data generating part RD2 generates first expected value data Dx(b(i−1),b(i)) in a look-up table format with the deviation of the front edge and the deviation of the rear edge as variables, from the row of read data c(i) obtained under the state shown in FIG. 7A. The expected value data generating part RD2 generates second expected value data Dy(b(i−1),b(i)) in a look-up table format with the deviation of the rear edge and the deviation of the front edge as variables, from the row of read data c(i) obtained under the state shown in FIG. 8A.

Suppose, for convenience of explanation, that the number of levels M of deviation is set at “4” and a total of 16 reference marks PT are to be recorded. First expected value data Dx(b(i−1),b(i)) such as shown in FIG. 7B is generated from 16 pieces of read data c(i) obtained under the state shown in FIG. 7A.

More specifically, in FIG. 7B, the variable b(i-l) shall range between deviations of the front edge “0” and “3,” and the variable b(i) between deviations of the rear edge “0” and “3.” Then, a total of 16 values of the read data c(i) corresponding to the variables b(i−1) and b(i), such as “0.16” and “0.23,” make the first expected value data Dx(b(i−1),b(i)).

Here, the reading light beam BM has a characteristics of nonlinear intensity distribution such that the intensity peaks at the center of the optical axis and decreases toward the periphery. In addition, the greater mark length the reference mark PT irradiated with the reading light beam BM has, the lower the intensity of the reflected light caused by the irradiation of the reading light beam BM becomes.

Consequently, actual measurements of intensity of the reflected light with respect to the deviations of the front edge and rear edge show a nonlinear distribution as shown in FIG. 7B.

Note that FIG. 7B shows the measurements of the intensity distribution Rx(b(i−1)) of the reflected light reflected from the left side of the spot area (i.e., a semicircular spot area) with respect to the mark reference position Qx shown in FIG. 7A and those of the intensity distribution Rx(b(i)) of the reflected light reflected from the right side of the spot area (i.e., a semicircular spot area) with respect to the mark reference position Qx on an identical plane.

As can be seen from this FIG. 7B, while the deviations of the front edge and the rear edge vary linearly, the intensities Rx(b(i−1)) and Rx(b(i)) of the reflected light do not make a linear change but a nonlinear change such as is represented by an arc which is convex downward.

The foregoing read data c(i) corresponds to the sums of the intensities Rx(b(i−1)) and Rx(b(i)), or Rx(b(i−1))+Rx(b(i)), of the reflected light for the same deviations shown in FIG. 7B. Thus, the first expected value data Dx(b(i−1),b(i)) shown in FIG. 7B is also generated as a group of data having the characteristics of the nonlinearly-changing intensity distributions Rx(b(i−1)) and Rx(b(i)) shown in FIG. 7B.

Meanwhile, the second expected value data Dy(b(i−1),b(i)) shown in FIG. 8B is also generated as a group of data having similar nonlinear characteristics.

More specifically, FIG. 8B shows on an identical plane the measurements of the intensity distribution Ry(b(i−1)) of the reflected light reflected from the left side of the spot area (i.e., a semicircular spot area) with respect to the space reference position Qy and those of the intensity distribution Ry(b(i)) of the reflected light reflected from the right side of the spot area (i.e., a semicircular spot area) with respect to the space reference position Qy when the center of the spot area of the reading light beam BM falls on the space reference position Qy as shown in FIG. 8A.

Even in such cases, the reading light beam BM has a nonlinear distribution such that the intensity peaks at the center of the optical axis and decreases toward the periphery. In addition, the reflected light of higher intensity occurs when the space reference positions Qy between the reference marks PT are irradiated with the reading light beam BM as compared to when the mark reference positions Qx of the reference marks PT are irradiated. On this account, the intensity distributions Ry(b(i−1)) and Ry(b(i)) show a nonlinear distribution such as is represented by an arc which is convex upward.

The foregoing read data c(i) corresponds to the sums of the intensities Ry(b(i−1)) and Ry(b(i)), or Ry(b(i−1))+Ry(b(i)), of the reflected light for the same deviations shown in FIG. 8B. Thus, the second expected value data Dy(b(i−1),b(i)) shown in FIG. 8B is also generated as a group of data having the characteristics of the nonlinearly-changing intensity distributions Ry(b(i−1)) and Ry(b(i)) shown in FIG. 8B.

Having generated the first expected value data Dx(b(i−1), b(i) and the second expected value data Dy(b(i−1),b(i)) in this way, the expected value data generating part RD2 stores the data into the expected value data memory part DB to complete the processing of generating the expected value data.

Now, description will be given of the function of the approximate analysis part RD1.

When the approximate analysis part RD1 is supplied with a row of read data c (i) which is obtained from a row of marks recorded in the program area, it determines the expected value data having values closest to the individual pieces of read data c(i) from the first expected value data Dx(b(i−1),b(i)) and the second expected value data Dy(b(i−1),b(i)) stored in the expected value data memory part DB through approximate operations.

More specifically, the pickup 3 reads a row of marks PT recorded in the program area, and supplies the approximate analysis part RD1 with a row of read data c(i) which is obtained when the center of the spot area of the reading light beam BM falls on the mark reference positions Qx as shown in FIG. 6A. The approximate analysis part RD1 refers to the first expected value data Dx(b(i−1),b(i)), and determines a single piece of expected value data having a value closest to the row of read data c(i).

For example, when a mark PT recorded with the number of levels M of deviation of “4” is read, a single expected value data having a value closest to the read data c(i) is determined from among the 16 pieces of expected value data Dx(b(i−1),b(i)) shown in FIG. 7B. Assuming, for example, that the closest expected value data is the value “0.23” in FIG. 7B, the expected value data Dx(1,0)=0.23 with the variables b(i−1) and b(i) of “1” and “0,” respectively, is determined as the closest expected value data.

Then, the variables b(i−1) and b(i) corresponding to the expected value data determined are supplied to the decoded value operation part RD3.

That is, given that the determined expected value is Dx(1,0)=0.23 mentioned above, the corresponding values “1” and “0” are supplied to the decoded value operation part RD3 as the variables b(i−1) and b(i), respectively.

Now, the pickup 3 reads a row of marks recorded in the program area, and supplies the approximate analysis part RD1 with a row of read data c(i) which is obtained when the center of the spot area of the reading light beam BM falls on the mark reference positions Qy as shown in FIG. 8A. The approximate analysis part RD1 refers to the second expected value data Dy(b(i−1),b(i)) and determines a single piece of expected value data having a value closest to the row of read data c(i).

For example, when a mark PT recorded with the number of levels M of deviation of “4” is read, a single piece of expected value data having a value closest to the read data c(i) is determined from among the 16 pieces of expected value data Dy(b(i−1),b(i)) shown in FIG. 8B. If the closest expected value data is the value “0.37” in FIG. 8B, the expected value data Dy(1,0)=0.37 having the variables b(i−1) and b(i) of “1” and “0,” respectively, is determined as the closest expected value data.

Then, the variables b(i−1) and b(i) corresponding to the expected value data determined are supplied to the decoded value operation part RD3.

That is, given that the determined expected value is Dy(1,0)=0.37 mentioned above, the corresponding values “1” and “0” are supplied to the decoded value operation part RD3 as the variables b(i−1) and b(i), respectively.

As above, the approximate analysis part RD1 determines expected value data having a value closest to each piece of the supplied read data c(i) from among the first expected value data Dx(b(i−1),b(i)) or the second expected value data Dy(b(i−1),b(i) depending on whether the center of the spot area of the reading light beam BM falls on a mark reference position Qx or a space reference position Qy. Besides, the approximate analysis part RD1 supplies the variables b(i−1) and b(i) corresponding to the determined expected value data to the decoded value operation part RD3.

Consequently, the approximate analysis part RD1 determines the variables b(i−1) and b(i) which show the deviations of the front and rear edges of each mark PT, respectively, and supplies the same to the decoded value operation part RD3.

Incidentally, the technique for obtaining expected value data having a closest value described above, or the approximate operation technique, may use a so-called least-squares approximation method, in which the square error between the read data c (i) and the expected value data Dx(b(i−1),b(i)) and the square error between the read data c(i) and the expected value data Dy(b(i−1),b(i)) are obtained to determine the condition for minimizing those square errors . Other approximation techniques may also be used.

For the sake of precision decoding, however, the present invention shall employ Viterbi decoding to determine the variables b(i−1) and b(i), showing the deviations of the front and rear edges of each mark PT, respectively, from the read data c(i) The details will be given later.

Now, description will be given of the function of the decoded value operation part RD3.

The decoded value operation part RD3 calculates decoded values e(i) by applying the variables b(i−1) and b(i) supplied from the approximate analysis part RD1 to an arithmetic formula expressed by the following equation (3).

e(i)=b(i−1)+b(i) (3)

Besides, the decoded values e(i) are applied to an arithmetic formula given by the following equation (4) to determine and output decoded data f(i).

f(i)=e(i)modM (4)

That is, a remainder operation with the number of levels M of deviation as the modulus is performed on the decoded values e(i) to calculate the decoded data f(i).

When obtained thus, the decoded data f(i) coincides with the recording data a(i) at the time of information recording shown in FIG. 1.

That is, the coding formula of the foregoing equation (1) satisfies the relationship that the values of the sums of the coded data b(i−1) and b(i), or b(i−1)+b(i), make the values of the original recording data a(i). Based on the coded data b(i−1) and b(i) which is determined in accordance with the coding formula of such relationship, individual marks PT are information-recorded.

Thus, in information reproduction, the decoded value operation part RD3 obtains the sums of the variables b(i−1) showing the deviations of the front edges of the respective marks PT and the variables b(i) showing the deviations of the rear edges, or b(i−1)+b(i), as the decoded values e(i). The decoded values e(i) then coincide with the original recording data a(i).

If the decoded values e(i) are used for the decoded data, however, the values of the decoded data may exceed the number of levels M of deviation. Thus, in the foregoing equation (4), the decoded data f(i) coincident with the original recording data a(i) is calculated by performing remainder operations on the decoded values e(i) with the number of levels M of deviation as the modulus.

As has been described, according to the present embodiment, coded data b(i−1) and b(i) is generated in information recording so as to satisfy the relationship that the values of the sums of the coded data b(i−1) and b(i), or b(i−1)+b(i), make the values of the original recording data a(i) as has been explained with reference to the foregoing equation (1). Using the coded data b(i−1) and b(i) as the deviations of the front and rear edges, respectively, individual marks PT are recorded on the optical disc 1. Meanwhile, in information reproduction, reference marks are read initially to generate first and second expected value data Dx(b(i-1),b(i)) and Dy(b(i−1),b(i)). Subsequently, as shown in FIG. 6A, adjoining front and rear edges recorded on the optical disc 1 are read at the same time. Expected value data having values closest to the resulting read data c(i) is determined out of the first and second expected value data Dx(b(i−1),b(i)) and Dy(b(i−1),b(i)). Furthermore, the variables b(i−1) and b(i) corresponding to the expected value data determined are applied to the foregoing equations (3) and (4) to obtain the decoded data f(i). It is therefore possible to reproduce the decoded data f(i) coincident with the original recording data a(i).

Moreover, in the information recording/reproducing method of the present embodiment, adjoining front and rear edges recorded on the optical disc 1 are read simultaneously. Thus, when individual marks PT are information-recorded according to the condition shown by the foregoing expression (2), the mark intervals T can be reduced with a significant improvement in recording density.

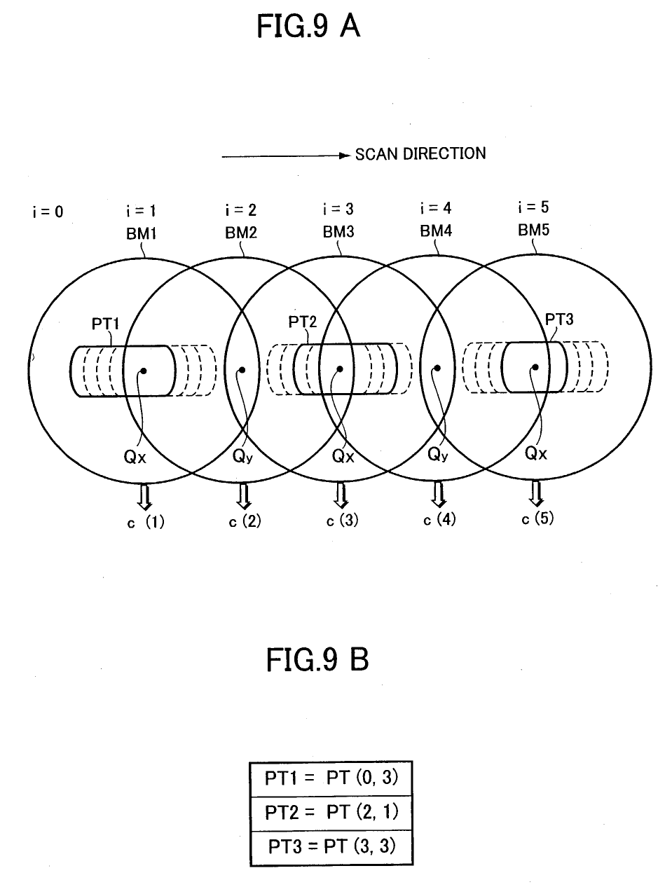

Now, with reference to FIGS. 9A through 12, description will be given of the process where the variable b(i−1) showing the deviation of the front edge of each mark PT and the variable b(i) showing the deviation of the rear edge are determined by the Viterbi decoding.

For convenience of explanation, the following description will be given on the assumption that information recording is performed with the number of levels M of deviation of the front and rear edges of individual marks set at “4,” and the marks are read for information reproduction.

It is also assumed that the row of reference marks is read already, and the expected value data memory part DB shown in FIG. 2 contains the first expected valued data Dx(b(i−1),b(i)) consisting of a group of data shown in FIG. 7B and the second expected value data Dy(b(i−1),b(i)) consisting of a group of data shown in FIG. 8B.

In addition, for convenience's sake, the description will be given on the assumption that the row of recording data a(i), or arbitrary values, is as follows: a(1)=3; a(2)=1; a(3)=3; a(4)=0; and a(5)=2.

In such a case, at the time of information recording, the coding shown by the foregoing equation (1) generates the coded data b(i) as follows: b(0)=0; b(1)=3; b(2)=2; b(3)=1; b(4)=3; and b(5)=3.

Then, individual marks PT(b(i−1),b(i)) are recorded by the write signals Sw which are generated based on the coded data b(i). Consequently, as shown in FIGS. 9A and 9B, the optical disc 1 contains a mark PT1 represented as PT(0,3), a mark PT2 represented as PT(2,1) and a mark PT3 represented as PT(3,3).

Then, information reproduction is started, and the pickup 3 reads and scans the marks PT1, PT2, and PT3 shown in FIG. 9A in succession. Here, the read data c(1), c(2), c(3), c(4), and c(5) having values of “0.40,” “0.80,” “0.40,” “10.70,” and “0.80,” respectively, shall be obtained from the reflected light occurring when the center of the spot area of the reading light beam BM falls on the mark reference positions Qx and the space reference positions Qy alternately.

That is, in an ideal case, the values of the read data c(1) c(2), c(3), c(4), and c(5) are expected to be “0.46,” “0.77,” “0.40,” “0.67,” and “0.76,” respectively, which correspond to the first expected value data Dx(b(i−1),b(i)) shown in FIG. 7B and the second expected value data Dy(b(i−1),b(i)) shown in FIG. 8B. Due to the influence of noise and the like, however, the read data c(1), c(2), c(3), c(4), and c(5) shall have values of “0.40,” “0.80,” “0.40,” “0.70,” and “0.80,” respectively.

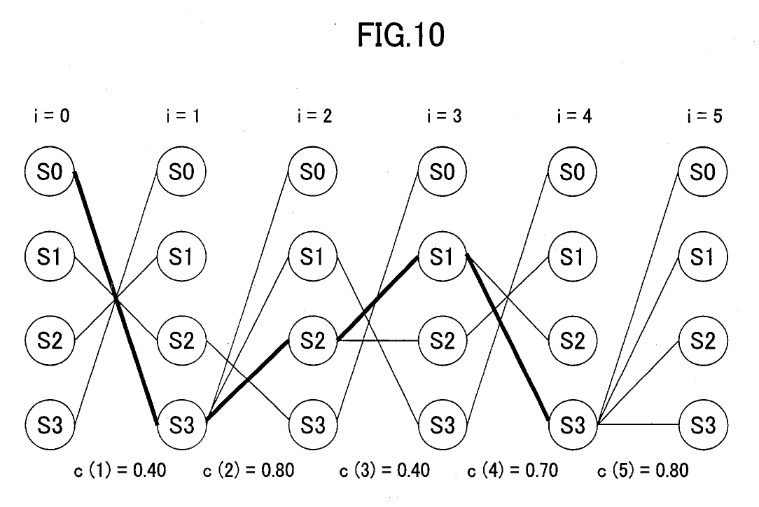

Under the circumstances, the approximate analysis part RD1 in FIG. 2 starts to decode based on the Viterbi decoding method, estimating the deviations b(i) of the front and rear edges of the individual marks PT1, PT2, PT3 . . . by using a state transition diagram (trellis diagram) as shown in FIG. 10.

More specifically, S₀, S₁, S₂, and S₃ shown in FIG. 10 represent the states where the front/rear edges of the marks PT1, PT2, PT3 . . . have deviations of b(i)=0, 1, 2, and 3, respectively, at sequences i=1, 2, 3, 4, 5 . . . when the read data c(1), c(2), c(3), c(4), c(5) is obtained.

Assuming that variables j and k are the deviation b(i−1) of the front edge and the deviation b(i) of the rear edge, respectively, the 16 pieces of expected value data Dx(b(i−1),b(i)) shown in FIG. 7B and the 16 pieces of expected value data Dy(b(i−1),b(i)) shown in FIG. 8B are written as expected value data dⱼₖ. Through the operation based on the following equation (5), square errors Bⱼₖ⁽ⁱ⁾ between the read data c(i) and the expected value data dⱼₖ are obtained. The square errors Bⱼₖ⁽ⁱ⁾ is regarded as a branch metrics for shifting from a state Sⱼ corresponding to the deviation b(i−1)=j to a state Sₖ corresponding to the deviation b(i)=k.

Bⱼₖ⁽ⁱ⁾=(c(i)−dⱼₖ)² (5)

When the center of the spot area of the reading light beam BM falls on a mark reference position Qx, the branch metrics Bⱼₖ⁽ⁱ⁾ is obtained by the application of the foregoing equation (5) with the first expected value data Dx(b(i−1),b(i)) as the expected value data dⱼₖ. When the center of the spot area of the reading light beam BM falls on a space reference position Qy, the Bⱼₖ⁽ⁱ⁾ is obtained by the application of the foregoing equation (5) with the second expected value data Dy(b(i−1),b(i)) as the expected value data dⱼₖ.

The smaller value the branch metrics Bⱼₖ⁽ⁱ⁾ obtained thus has, the higher the transition probability from the state Sⱼ to the next state Sₖ is. The probability of occurrence peaks upon the state transition where the sum of a plurality of branch matrices Bⱼₖ⁽ⁱ⁾ from the start of decoding to the ith state Sₖ becomes minimum in value. Then, the deviations b(i−1) and b(i) corresponding to the state Sₖ at each number i on the path matrices for the maximum probability of occurrence are determined and supplied to the decoded value operation part RD3 shown in FIG. 2.

To be more specific, the Viterbi decoding is performed through the following processing.

Initially, the foregoing path matrices are calculated by a recurrence formula expressed as the following equation (6).

Pₖ⁽ⁱ⁾=min[Pⱼ⁽ⁱ⁻¹⁾+Bⱼₖ⁽ⁱ⁾]_{0≦j≦M·1} provided that Pⱼ⁽⁰⁾=0 (6)

Incidentally, the foregoing equation (6) shows that the path metrics Pₖ⁽ⁱ⁾ consists of minimum values to be obtained when the variable j ranges from 0 to M−1.

Initially, the approximate analysis part RD1 acquires the first (i=1) read data c(1) shown in FIG. 9A, and applies the read data c(1) and the expected value data dⱼₖ shown in FIG. 7B to the foregoing equation (6) to perform the following operations (7).

$$\begin{matrix}\begin{matrix}\begin{matrix}{p}_{0}^{( 0 )} + {B}_{00}^{( 1 )} = {( c ( 1 ) - {d}_{00} )}^{2} = {( 0.40 - 0.16 )}^{2} = {0.24}^{2} \\ {p}_{1}^{( 0 )} + {B}_{10}^{( 1 )} = {( c ( 1 ) - {d}_{10} )}^{2} = {( 0.40 - 0.23 )}^{2} = {0.17}^{2}\end{matrix} \\ {p}_{2}^{( 0 )} + {B}_{20}^{( 1 )} = {( c ( 1 ) - {d}_{20} )}^{2} = {( 0.40 - 0.33 )}^{2} = {0.07}^{2}\end{matrix} \\ {p}_{3}^{( 0 )} + {B}_{30}^{( 1 )} = {( c ( 1 ) - {d}_{30} )}^{2} = {( 0.40 - 0.46 )}^{2} = {0.06}^{2}\end{matrix} \qquad ( 7 )$$

Of these, P₃⁽⁰⁾+B₃₀⁽¹⁾=0.06² at the minimum. To reach the first (i=1) state S₀ in FIG. 10, the path through the zeroth (i=0) state S₃ provides the maximum probability of occurrence.

Then, the zeroth (i=0) state S₃ and the first (i=1) state S₀ are concatenated each other with the path metrics P₀⁽¹⁾ as P₃⁽⁰⁾+B₃₀⁽¹⁾.

Next, the zeroth (i=0) state Sⱼ to reach the first (i=1) state S₁ with the maximum probability of occurrence is obtained. That is, the following operations (8) are performed.

$$\begin{matrix}\begin{matrix}\begin{matrix}{p}_{0}^{( 0 )} + {B}_{01}^{( 1 )} = {( c ( 1 ) - {d}_{01} )}^{2} = {( 0.40 - 0.23 )}^{2} = {0.17}^{2} \\ {p}_{1}^{( 0 )} + {B}_{11}^{( 1 )} = {( c ( 1 ) - {d}_{11} )}^{2} = {( 0.40 - 0.30 )}^{2} = {0.10}^{2}\end{matrix} \\ {p}_{2}^{( 0 )} + {B}_{21}^{( 1 )} = {( c ( 1 ) - {d}_{21} )}^{2} = {( 0.40 - 0.40 )}^{2} = {0.00}^{2}\end{matrix} \\ {p}_{3}^{( 0 )} + {B}_{31}^{( 1 )} = {( c ( 1 ) - {d}_{31} )}^{2} = {( 0.40 - 0.53 )}^{2} = {0.13}^{2}\end{matrix} \qquad ( 8 )$$

Of these, P₂⁽⁰⁾+B₂₁⁽¹⁾=0.00² at the minimum. To reach the first (i=1) state S₁ in FIG. 10, the path through the zeroth (i=0) state S₂ provides the maximum probability of occurrence.

Then, the zeroth (i=0) state S₂ and the first (i=1) state S₁ are concatenated each other with the path metrics P₁⁽¹⁾ as P₂⁽⁰⁾+B₂₁⁽¹⁾.

Then, the zeroth (i=0) state Sⱼ to reach the first (i=1) state S₂ and state S₃ with the maximum probability of occurrence is obtained similarly.

That is, when the first (i=1) state S₂ is reached with the maximum probability of occurrence, the path metrics P₂⁽¹⁾ is given by:

P₂⁽¹⁾=P₁⁽⁰⁾+B₁₂⁽¹⁾=(c(1)−d₁₂)²=(0.40−0.40)²=0.00² (9)

The zeroth (i=0) state S₁ and the first (i=1) state S₂ are thus concatenated.

When the first (i=1) state S₃ is reached with the maximum probability of occurrence, the path metrics P₃⁽¹⁾ is given by:

P₃⁽¹⁾=P₀⁽⁰⁾+B₀₃⁽¹⁾=(c(1)−d₀₃)²=(0.40−0.46)²=0.06² (10)

The zeroth (i=0) state S₀ and the first (i=0) state S₃ are thus concatenated.

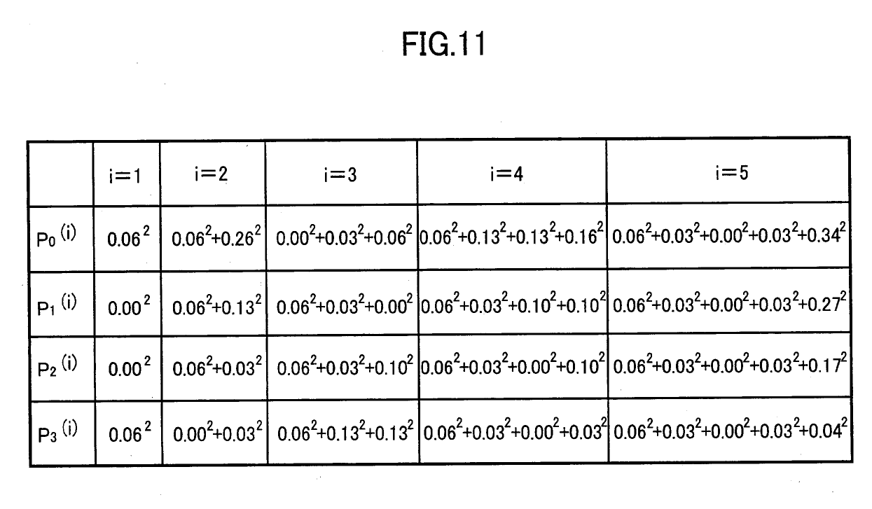

Moreover, path matrices Pₖ⁽²⁾, Pₖ⁽³⁾, and Pₖ⁽⁵⁾ are similarly calculated for situations where the states S₀, S₁, S₂, and S₃ at the remaining sequences i=2, 3, 4, and 5 shown in FIG. 10 are reached with respective maximum probabilities of occurrence. As a result, path matrices as listed in FIG. 11 are obtained.

Based on the path matrices shown in FIG. 11, the individual states shown in FIG. 10 are concatenated to complete the trellis diagram, determining a path which concatenates zeroth (i=0) through fifth (i=5) states.

The thick line in FIG. 10 shows the path. The states S₀, S₃, S₂, S₁, and S₃ lying on the path are thus determined, obtaining the deviations b(0), b(1), b(2), b(3), and b(4) corresponding to the respective states.

Here, FIG. 10 does not show the path from the fourth (i=4) to the fifth (i=5) in a thick line for convenience of explanation. The path to concatenate fourth (i=4) and fifth (i=5) states is determined when the trellis diagram is drawn for the sixth and later (6≦i). The value of the deviation b(5) is obtained thus. Incidentally, when the trellis diagram for the sixth and later (6≦i) is created, the value of the deviation b(5) shall be determined as “3.”

The deviations b(0), b(1), b(2), b(3), b(4), b(5) have values of “0,” “3,” “2,” “1,” “3,” and “3,” respectively. These deviation values are supplied as b(i−1) and b(i) to the decoded value operation part RD3 shown in FIG. 2.

When the decoded value operation part RD3 is thus supplied with the values of the deviations as b(i−1) and b(i), it performs the operation of the foregoing equation (3) to determine decoded values e(i). The decoded values e(i) are then applied to the foregoing equation (4) to generate the decoded data f(i).

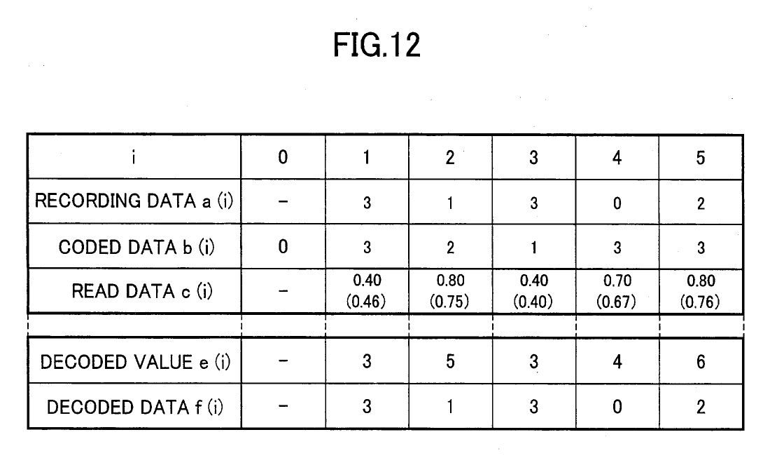

The process of the Viterbi decoding described above will now be summarized with reference to FIG. 12. When the row of recording data a(i) has values of “3,” “1,” “3,” “0,” and “2” at the time of information recording, the write signal generating part 11 performs the operation of the foregoing equation (1) to generate the row of coded data b(i) which starts with a value of “0,” followed by values of “3,” “2,” “1,” “3,” and “3.” Then, a row of marks PT having front and rear edges deviated in accordance with the row of coded data b(i) is recorded on the optical disc 1. Besides, a row of M×M reference marks PT having M levels of deviation is also recorded in a predetermined area of the optical disc 1.

At the time of information reproduction, the row of reference marks PT is read initially to generate the first and second expected value data dⱼₖ. Subsequently, the foregoing row of marks PT recorded in the program area of the optical disc 1 is read for reproduction. The resulting read data c(i) is supplied to the approximate analysis part RD1, at which time the Viterbi decoding is started.

Then, in the Viterbi decoding, the operations of the foregoing equations (5) and (6) are performed based on the read data c(i) and the first and second expected value data dⱼₖ. From the resulting trellis diagram, the deviations b(i) of the front and rear edges of the individual marks PT are estimated and supplied to the decoded value operation part RD3.

The decoded value operation part RD3 applies the values of the deviations b(i) supplied from the approximate analysis part RD1 to the foregoing equation (3) to determine a plurality of decoded values e(i) of “3,” “5,” “3,” “4,” and “6.” The decoded value operation part RD3 also applies these decoded values e(i) to the foregoing equation (4) to obtain decoded data f(i) having values of “3,” “1,” “3,” “0,” and “2.”

As can be seen from FIG. 12, the decoded data f(i) obtained through the Viterbi decoding thus coincides with the original recording data a(i).

In particular, as stated previously, it is possible to reproduce the decoded data f(i) coincident with the original recording data a(i) even when the read data c(i) does not have ideal values due to the influence of noise and the like. The decoding can thus be performed at extremely high precision.

In FIG. 9, a concrete example has been given for situations where three marks PT1, PT2, and PT3 are recorded, and the deviations of the front and rear edges of the three marks PT1, PT2, and PT3 are reproduced as the decoded data f(i). When a row of three or more marks PT is recorded, it is also possible to obtain the row of decoded data f(i) corresponding to the deviations of the front and rear edges of the row of marks PT in the row by successively performing the above-described Viterbi decoding on the row of read data c(i) obtained from the row of marks PT.

Moreover, as shown in FIGS. 7A though 8B, the first and second expected value data dⱼₖ are established in M×M pieces each, based on the read data of the row of reference marks having their front and rear edges deviated in M levels. Thus, the nonlinear distribution characteristics of the reading light beam BM, if any, also have effect on the expected value data dⱼₖ. Consequently, at the time of information reproduction, the information on the row of marks PT, i.e., the original recording data can be decoded by the foregoing Viterbi decoding or the like accurately even when the read data c(i) obtained through the simultaneous reading of front and rear edges in the row of marks PT is affected by the nonlinear distribution characteristics of the reading light beam BM.

This allows decoding which makes full use of the characteristics of the Viterbi decoding, with the excellent effect that the decoding can be achieved with high precision.

When the front and rear edges are deviated in a plurality of levels M, the expected value data dⱼₖ, as shown in FIGS. 7B and 8B, displays a so-called symmetry such that a plurality of pieces of expected value data lying in the right domain and a plurality of pieces of expected value data lying in the left domain are identical in value across the plurality of pieces of expected value data falling on the diagonal from the upper left to the lower right. Then, it may be decided not to record the entire row of reference marks consisting of the combinations of M×M reference marks in the predetermined area of the optical disc 1. Here, either one of the rows of redundant reference marks is not recorded as a row of reference marks, so that a row of nonredundant reference marks is recorded alone.

In such a case, M(M+1)/2 reference marks have only to be recorded to allow reproduction of all the expected value data dⱼₖ. This can advantageously reduce the number of reference marks to be recorded in a row.

For a concrete example, assuming that M=4, the total number of reference marks to be recorded can be reduced to 10.

Alternatively, reference marks fewer than M×M or M(M+1)/2 described above may be recorded on the optical disc. At the time of information reproduction, those reference marks are read to obtain expected value data. When the expected value data lacks, interpolating operations are performed based on the expected value data to generate the lack of the expected value data.

In FIGS. 7B and 7C, the expected value data dⱼₖ (i.e., Dx(j,k)) holds for Dx(j,k)=Rx(j)+Rx(k). In FIGS. 8B and 8B, the expected value data dⱼₖ (i.e., Dy(j,k)) holds for Dy(j,k)=Ry(j)+Ry(k). The M×M pieces of expected value data thus have a degree of freedom of M each. For this reason, it is sufficient to record at least M reference marks on the optical disc.

For example, the expected value data Dx(0,0), Dx(1,1) . . . Dx(M−1, M−1) in the foregoing diagonal positions in FIG. 7B may be obtained to determine the expected value data Dx(j,k) in the non-diagonal positions (in the foregoing right and left domains) by interpolating operations of Dx(j,k)={Dx(j,j)+Dx(k,k)}/2. Similarly, the expected value data Dy(0,0), Dy(1,1) . . . Dy(M−1,M−1) in the foregoing diagonal positions in FIG. 8B may be obtained to determine the expected value data Dy(j,k) in the non-diagonal positions (in the foregoing right and left domains) by interpolating operations of Dy(j,k)={Dy(j,j)+Dy(k,k)}/2.

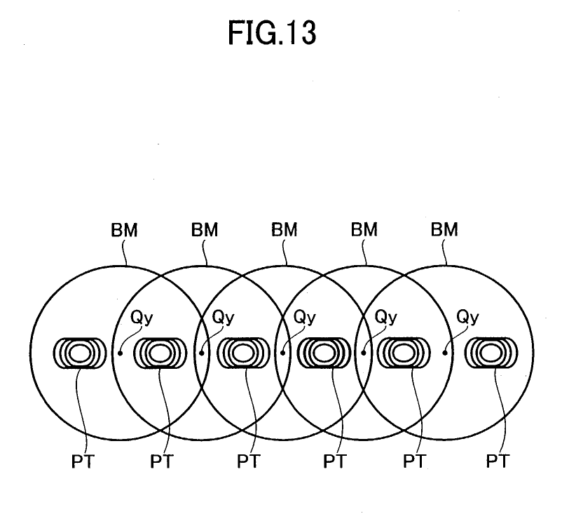

Moreover, in the foregoing description of the embodiment, the individual marks PT are recorded so that their front and rear edges are deviated differently in the track direction as shown in FIG. 6A etc. In information reproduction, adjoining front and rear edges are read at the same time when the spot area of the information reading light beam BM falls on the mark reference positions Qx and the space reference positions Qy. For a modified example of the present embodiment, recording and reproduction may be performed as illustrated in FIG. 13.

Specifically, in the embodiment shown in FIG. 6A, when the spot area of the information reading light beam BM falls on a mark reference position Qx, the front and rear edges of a mark PT corresponding to that position are read simultaneously. When the spot area falls on a space reference position Qy, the front and rear edges of adjoining marks PT corresponding to that position are read simultaneously.

On the contrary, in the modified example shown in FIG. 13, when the spot area of the information reading light beam BM falls on a space reference position Qy, two adjoining marks PT corresponding to that position are read at the same time. The information reading light beam BM is then moved (to scan) in the track direction, and each time the spot area moves to the subsequent space reference positions Qy in succession, two marks PT are simultaneously read in the same way.

Here, in information recording, the mark length of each mark PT is set within the range of M levels according to the recording data a(i), instead of the front and rear edges of each mark PT being deviated separately according to the recording data a(i).

Otherwise, each mark PT is recorded with its mark width set within the range of M levels according to the recording data a(i).

Alternatively, each mark PT is recorded with its mark width and mark length set within the range of M levels according to the recording data a(i).

That is, in information recording, each mark PT is recorded with its mark width and/or mark length set in accordance with the recording data a(i) so that the reflected light resulting from the irradiation of the reading light beam BM at the time of information reproduction varies in power (intensity) depending on the mark length and/or mark width of the mark PT.

Then, information reproduction is performed to read two marks PT simultaneously each time the spot area of the reading light beam BM falls on a space reference position Qy. The resulting read data c(i) is subjected to an approximate analysis such as the Viterbi decoding described previously. Individual pieces of the read data c(i) and predetermined reference data dⱼₖ are compared to determine the reference data dⱼₖ having closest values, based on which the decoded data f(i) coincident with the original recording data a(i) established as the mark lengths and/or mark widths of the individual marks PT, is decoded.

Here, as in FIG. 5, the reference data dⱼₖ is recorded as a row of reference marks in a predetermined area of the optical disc 1. Besides, in this modified example, the row of reference marks is recorded with mark lengths and mark widths established based on M levels of combinations which are determined to specify the mark lengths and mark widths of so-called recording marks PT, the targets of information reproduction shown in FIG. 13.

As with the case of reading the marks PT shown in FIG. 13, the reference marks are selected in twos simultaneously to obtain the reference data dⱼₖ. The Viterbi decoding or the like is performed based on the obtained reference data dⱼₖ and the read data c(i).

According to this modified example, multilevel recording can be realized simply by modulating the mark lengths or mark widths of the respective marks. Consequently, the recording and reproduction can be achieved more easily than when the front and rear edges of each mark are deviated separately for recording/reproduction.

The intervals at which the reading light beam BM reads the marks PT in twos, or the intervals between the adjoining space reference positions Qy shown in FIG. 13, can be made approximately the same as the Qx-Qy intervals described with reference to FIG. 6(a). It is therefore possible to realize recording/reproduction suitable for high density recording.

In the embodiment described with reference to FIG. 6A, adjoining front and rear edges are read simultaneously when the spot area of the reading light beam BM falls on the mark reference positions Qx and the space reference positions Qy. Consequently, when the spot area falls on a mark reference position Qx, there occurs reflected light which carries information on an entire mark PT. When the spot area falls on a space reference position Qy, there occurs reflected light which carries much information on the space between marks PT. On that account, the expected value data Dx(b(i−1),b(i)) and Dy(b(i−1),b(i)) for indicating two types of states shown in FIGS. 7A through 8B are used as the expected value data dⱼₖ.

On the contrary, in the modified example, two marks PT are read simultaneously only when the spot area of the reading light beam BM falls on the space reference positions Qy, not when the spot area falls on the mark reference positions Qx. The reflected light occurring upon read thus shows only a single state that two marks PT are irradiated with the reading light beam BM. This eliminates the need for such expected value data dⱼₖ for indicating two states as is shown in FIGS. 7A through 8B.

It is therefore possible to apply a single group (single state) of expected value data dⱼₖ for the Viterbi decoding. Moreover, individual reference marks need not be recorded with their front and rear edges deviated separately, while it is possible to provide such effects that high density recording/reproduction can be achieved with facility.

The embodiment including the foregoing modified example has dealt with the case where recording and reproduction are performed by using the optical disc 1 which is capable of information recording. That is, the description has been given of the case where recording and reproduction are performed on an optical disc having a recording surface containing a dye which varies in optical characteristics under a writing light beam, or an optical disc having a recording surface of phase change type capable of repeated information recording and erase.

However, the present invention is not limited to these optical discs, but is applicable even when recording and reproduction are performed on magneto-optic discs such as an M0.

Moreover, the information reproducing method of the present invention may also be applied to a reproduction-only information reproducing apparatus for reproducing information from a read-only optical disc which is given the multilevel recording described in the present embodiment including the modified example.

Besides, when information-recorded optical discs are intended to be offered to users who possess information recording/reproducing apparatuses or information reproducing apparatuses having the information reproducing function described in the embodiment including the modified example, the information recording method of the present invention can also be applied to an information recording apparatus for producing those optical discs.

As has been described, according to the present invention, adjoining front and rear edges in a row of marks are optically read at the same time. Read data obtained by the simultaneous reading is compared with a plurality of pieces of expected value data which show a plurality of levels of deviation determined in advance. Based on the result, the deviations of the front and rear edges of the individual marks read simultaneously are determined to decode multilevel data. Here, the expected value data is set based on the combinations of deviations of the front and rear edges of each mark. Thus, when the decoding is effected by the Viterbi decoding or the like, it is possible to decode read data even having nonlinear characteristics, optically read from the individual marks, into multilevel data with high accuracy. This makes it possible to realize recording and reproduction corresponding to information recording media of higher densities, and by extension to contribute to information recording media of higher densities.

Moreover, according to the information recording medium of the present invention, the reference marks recorded can provide expected value data to be used in the foregoing information reproduction. It is therefore possible to realize high quality information reproduction from an information recording medium recorded at high density.

The present application claims priority from Japanese Patent Application No. 2002-157372, the disclosure of which is incorporated herein by reference.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. An information reproducing apparatus for reproducing an information recording medium, a row of marks being recorded on a track on said information recording medium with individual mark ends deviated in M levels (M is a positive integer) so that said mark ends re cord M-valued multilevel data, the apparatus comprising:
a reader for optically reading two mark ends adjoining in front and behind on said track at the same time, and outputting read data; and
a decoder for reproducing said multilevel data based on a result of comparison between a level of said read data and a plurality of expected values, wherein
said expected values have respective different levels each of which corresponds to a combination of two pieces of multilevel data recorded on said mark end, respectively.

2. The information reproducing apparatus according to claim 1, wherein:
a row of M or more predetermined reference marks out of M x M marks having their front and rear edges deviated in position in M levels independently is recorded on said information recording medium as expected value data;
said reader optically reads and scans said row of M or more reference marks, generates a portion of said expected value data from M or more pieces of first read data obtained by reading the front edge and the rear edge of each of said reference marks simultaneously and M or more pieces of second read data obtained by reading the rear edge of either one of adjoining reference marks and the front edge of the other simultaneously, and generates the rest of said expected value data through an interpolating operation on said portion of said expected value data; and
said decoder includes an approximate analyzer for comparing read data generated by said reader simultaneously reading the front edge and rear edge of each recording mark to said expected value data generated from said first read data, comparing read data generated by said reader simultaneously reading the rear edge of either one of adjoining recording marks and the front edge of the other to said expected value data generated from said second read data, and determining deviations of the front edges and rear edges of said recording marks based on the results of comparison.

3. The information reproducing apparatus according to claim 2, wherein said approximate analyzer performs Viterbi decoding to determine deviations of the front edges and rear edges of said recording marks from said expected value data and the read data of said recording marks generated by said reader.

4. An information reproducing apparatus for reproducing an information recording medium, a row of marks being recorded on a track on said information recording medium with respective mark sizes deviated in M levels (M is a positive integer) so that said marks record M-valued multilevel data, the apparatus comprising:
a reader for optically reading two marks adjoining in front and behind on said track at the same time, and outputting read data; and
a decoder for reproducing said multilevel data based on a result of comparison between a level of said read data and a plurality of expected values, wherein
said expected values have respective different levels each of which corresponds to a combination of two pieces of multilevel data recorded on said two marks, respectively.

5. An information recording/reproducing apparatus for recording and reproducing recording data on/from an information recording medium, the apparatus comprising:
a mark end deviating device for recording a row of marks on a track on said information recording medium so that individual mark ends are deviated in M levels in accordance with M-valued multilevel data (M is a positive integer);
a reader for optically reading two mark ends adjoining in front and behind on said track at the same time, and outputting read data; and
a decoder for reproducing said multilevel data based on a result of comparison between a level of said read data and a plurality of expected values, wherein
said expected values have respective different levels each of which corresponds to a combination of two pieces of multilevel data recorded on said mark end, respectively.

6. The information recording/reproducing apparatus according to claim 5, comprising
a recorder for recording, on said information recording medium, a row of M or more predetermined reference marks out of M×M marks having their front and rear edges deviated in M levels independently, wherein:
said reader optically reads and scans said row of M or more reference marks, generates a portion of said expected value data from M or more pieces of first read data obtained by reading a front edge and a rear edge of each of said reference marks simultaneously and M or more pieces of second read data obtained by reading the rear edge of either one of adjoining reference marks and the front edge of the other simultaneously, and generates the rest of said expected value data through an interpolating operation on said portion of said expected value data; and
said decoder includes an approximate analyzer for comparing read data generated by said reader simultaneously reading the front edge and rear edge of each recording mark to said expected value data generated from said first read data, comparing read data generated by said reader simultaneously reading the rear edge of either one of adjoining recording marks and the front edge of the other to said expected value data generated from said second read data, and determining deviations of the front edges and rear edges of said recording marks based on the results of comparison.

7. The information recording/reproducing apparatus according to claim 6, wherein said approximate analyzer performs Viterbi decoding to determine deviations of the front edges and rear edges of said recording marks from said expected value data and the read data of said recording marks generated by said reader.

8. The information recording/reproducing apparatus according to claim 5, wherein said mark end deviating device records said row of recording marks with mark lengths smaller than a diameter of a spot area resulting from irradiation of a reading light beam when a front edge and a rear edge of each of said recording marks are optically read at the same time.

9. An information recording/reproducing apparatus for recording and reproducing recording data on/from an information recording medium, the apparatus comprising:
a mark size deviating device for recording a row of marks on a track on said information recording medium so that respective mark sizes are deviated in M levels in accordance with M-valued multilevel data (M is a positive integer);
a reader for optically reading two marks adjoining in front and behind on said track at the same time, and outputting read data; and
a decoder for reproducing said multilevel data based on a result of comparison between a level of said read data and a plurality of expected values, wherein
said expected values have respective different levels each of which corresponds to a combination of two pieces of multilevel data recorded on said two marks, respectively.

10. An information reproducing method for reproducing information from an information recording medium, a row of marks being recorded on a track on said information recording medium with individual mark ends deviated in M levels (M is a positive integer) so that said mark ends record M-valued multilevel data, the method comprising:
a reading step of optically reading two mark ends adjoining in front and behind on said track at the same time, and outputting read data; and
a decoding step of reproducing said multilevel data based on a result of comparison between a level of said read data and a plurality of expected values, wherein
said expected values have respective different levels each of which corresponds to a combination of two pieces of multilevel data recorded on said mark end, respectively.

11. An information recording/reproducing method for recording and reproducing recording data on/from an information recording medium, the method comprising:
a mark end deviating step of recording a row of marks on a track on said information recording medium so that individual mark ends are deviated in M levels in accordance with M-valued multilevel data (M is a positive integer);
a reading step of optically reading two mark ends adjoining in front and behind on said track at the same time, and outputting read data; and
a decoding step of reproducing said multilevel data based on a result of comparison between a level of said read data and a plurality of expected values, wherein
said expected values have respective different levels each of which corresponds to a combination of two pieces of multilevel data recorded on said mark end, respectively.

12. An information recording medium for an information reproducing apparatus to reproduce information from or an information recording medium for an information recording/reproducing apparatus to record/reproduce information on/from, wherein
a row of M or more predetermined reference marks out of M×M marks having their front and rear edges deviated in position in M levels independently (M is a positive integer) is recorded on the information recording medium.

13. The information recording medium according to claim 12, wherein said row of reference marks is recorded in a predetermined area on a predetermined recording surface.
